(19) United States
(12) Patent Application Publication
(10) Pub. No.: US 2006/0202607 A1
(43) Pub. Date: Sep. 14, 2006

(54) Thin film electron emitter, manufacturing method thereof, and image display device using the thin film electron emitter

(76) Inventors: Yasushi Sano, Yokohama (JP); Takuo Tamura, Yokohama (JP); Hiroshi Kikuchi, Zushi (JP); Kazushi Miyata, Mobara (JP); Kazuhiro Fukuchi, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,690

(22) Filed: Mar. 6, 2006

(30) Foreign Application Priority Data
Mar. 11, 2005 (JP) 2005-068974

(51) Int. Cl. H01J 63/04

(52) U.S. Cl. 313/495

(57) ABSTRACT

In an image display device having, in each pixel, an electron emitter containing a first electrode, an insulating layer, and a second electrode arranged in this order, the insulating layer is formed by anodic oxidation using the first electrode and has defects, if any, in a number of 3×10¹⁹ or less cubic centimeter. The electron emitter has a longer life, and the image display device using the electron emitter has improved reliability and image quality.

The present application claims priority from Japanese application JP 2005-068974 filed on Mar. 11, 2005, the content of which is hereby incorporated by reference into this application.

### BACKGROUND OF THE INVENTION

1. Field of the Invention

The present invention relates to thin-film electron emitters, production methods thereof, and image display devices using the thin-film electron emitters.

2. Description of the Related Art

A thin-film electron emitter is a kind of electron emitters and basically structurally has a multilayer structure of three thin films, i.e., a top electrode, an electron acceleration layer, and a bottom electrode arranged in this order. A voltage is applied to between the top electrode and the bottom electrode to thereby allow the electron emitter to emit electrons into a vacuum.

Examples of such multilayer structures are a MIM (metal-insulator-metal) structure containing metal-insulator-metal arranged in this order; a MIS (metal-insulator-semiconductor) structure containing metal-insulator-semiconductor arranged in this order; and a metal-insulator-semiconductor-metal structure. The MIM structure is disclosed in, for example, Japanese Patent Laid-open Publication (referred to as JP-A, hereinafter) No. 1995-65710 (Patent Document 1), and the metal-insulator-semiconductor structure is known as a MOS structure described, for example, in J. Vac. Sci. Techonol. B11 (2) pages 429-432 (1993) (Non-patent Document 1). The metal-insulator-semiconductor-metal structures include a structure using a high efficiency electro-emission device (HEED) as a semiconductor, described typically by Negishi et al., in “high-efficiency-electro-emission device,” Jpn. J. Appl. Phys. vol. 36, pages L939-L941 (1997) (Non-patent Document 2); a structure using an electroluminescent (EL) thin film as a semiconductor, described typically by S. Okamoto in “Electron emission from electroluminescent thin film—thin film cold electron emitter-” (in Japanese), OYO BUTURI (Applied Physics), vol. 63, No. 6, pages 592-595 (1994) (Non-Patent Document 3); and a structure using a porous silicon as a semiconductor, described typically by N. Koshida in “Light emission from porous silicon - - -Beyond the indirect/direct transition regime - - - ,” (in Japanese), OYO BUTURI (Applied Physics), vol. 66, No. 5, pages 437-443(1997) (Non-patent Document 4).

The operation principle of thin-film electron emitters will be illustrated with reference to FIG. 1 by taking an electron emitter having an MIM structure (hereinafter also referred to as MIM thin-film electron emitter) as an example. FIG. 1 is an explanatory view of the operation principle of the MIM thin-film electron emitter. The MIM thin-film electron emitter includes an insulating substrate made typically of glass; a first electrode (hereinafter also referred to as bottom electrode) 11 arranged on the insulating substrate; an insulating layer (hereinafter also referred to as electron acceleration layer) 12 arranged on the bottom electrode 11; and a second electrode (hereinafter also referred to as top electrode) 13 covering the insulating layer 12. When a drive voltage Vd is applied to between the top electrode 13 and the bottom electrode 11 to generate an electric field of about 1 to about 10 MV/cmin the insulating layer 12 serving as an electron acceleration layer, electrons in the vicinity of the Fermi level in the bottom electrode 11 pass through a barrier as a result of tunneling, are injected into conduction bands of the electron acceleration layer 12 and the top electrode 13 and become hot electrons.

These hot electrons are scattered in the insulating layer 12 as an electron acceleration layer and the top electrode 13 and thereby lose their energy, but some of them having energy equal to or greater than the work function φ of the top electrode 13 are emitted into a vacuum 20.

The thin-film electron emitters of other types are in common with the MIM thin-film electron emitter in that, in the above-mentioned multilayer structure, electrons are accelerated, passed through a thin top electrode, such as a metal layer, constituting the multilayer structure, and emitted into a vacuum. By arranging top electrodes and bottom electrodes so as to intersect with each other, for example, perpendicularly, and arranging such thin-film electron emitters in a matrix at plural intersecting points between the top electrodes and the bottom electrodes, electron beams can be emitted at an arbitrary intersecting point between the top electrodes and the bottom electrodes. This matrix array of thin-film electron emitters can be applied typically to image display devices.

The electron emission has been observed, for example, in a MIM (metal-insulator-metal) structure including a multilayer structure of Au (gold)-Al₂O₃ (alumina)-Al (aluminum). In a thin-film electron emitter array including two-dimensionally arranged thin-film electron emitters, thin top electrodes are used as the individual electron emitters. Accordingly, to apply the thin-film electron emitter array typically to image display devices, top bus electrodes serving as feeders for the top electrodes of the thin-film electron emitters are added to the array.

### SUMMARY OF THE INVENTION

Anodized films (anodically oxidized films) are used as the insulating layer serving as an electron acceleration layer of the above-mentioned thin-film electron emitter. The bottom electrode (first electrode) of the thin-film electron emitter is formed by aluminum or aluminum-alloy. The anodized film is formed in a solution mainly containing an organic solvent (a forming solution) by immersing the bottom electrode. Therefore, the resulting anodized film contains impurities such as carbon. The impurities in the anodized film form defects therein. If such an anodized film having a large amount of defects is used as an electron acceleration layer, the resulting electron acceleration layer has impaired insulating property, the electron emitter has impaired reliability due to injection of charges into the defects in the electron acceleration layer. This impairs the life of the electron emitter. In this connection, Patent Document 2 discusses reduction of impurities in an anodized film covering a gate electrode of an insulating-gate field-effect transistor and resulting reduction of the turn-off current of the field-effect transistor. Patent Document 2, however, only discusses the insulating properties of anodized films and fails to discuss the problems of anodized films as the electron acceleration layers of thin-film electron emitters.

Accordingly, an object of the present invention is to provide a thin-film electron emitter that includes an anodized film having reduced defects and thereby shows a higher reliability and a longer life. Another object of the present invention is to provide an image display device using the thin-film electron emitter.

The present invention therefore provides a thin-film electron emitter including an insulating substrate, a first electrode, an insulating layer, and a second electrode, each arranged in this order, in which the insulating layer is an anodized film and has reduced defects, if any, in a number of 3×10¹⁹ or less per cubic centimeter (/cm³). The insulating layer may have a thickness of about 5 nm to about 15 nm.

The present invention further provides a method which produces a thin-film electron emitter by depositing a layer of aluminum and/or an aluminum alloy on an insulating substrate to thereby form a first electrode, applying anodic oxidation to the first electrode under the following conditions to thereby form an insulating layer. The conditions in the step (anodic oxidation step) of applying a voltage between the first electrode and an electrode which is immersed in the solution (forming solution) with the first electrode are such that the voltage is raised at a rate of about 0.15 V or less per minute; in the course of raising the voltage applied between the electrodes (anodizing voltage), the current generated between the electrodes is controlled in density to about 0.01 mA or less per square centimeter (/cm²), and the highest voltage which the applied voltage reaches is set within a range of about 3 V to about 9 V.

In addition and advantageously, the present invention provides an image display device including a back substrate (for constituting the backside of an image display panel), a front substrate (for constituting the front side of the image display panel), and a frame (sealing frame), in which the sealing frame is arranged between the peripheries of the back substrate and the front substrate so as to allow the two substrates to face each other at a predetermined distance and serves to seal the inner space formed between the two substrates to a predetermined reduced pressure (in vacuo). The back substrate includes plural scanning signal interconnections extending in one direction on the insulating substrate and being arranged in parallel in another direction intersecting, for example, perpendicularly, with the one direction, scanning signals being to be applied to the scanning signal interconnections sequentially in the other direction; plural picture signal interconnections extending in the other direction and being arranged in parallel in the one direction so as to intersect with the scanning signal interconnections; thin-film electron emitters arranged at intersections between the scanning signal interconnections and the picture signal interconnections; and bus electrodes each connected to the scanning signal interconnections so as to supply a current to the thin-film electron emitters.

In this image display device, the thin-film electron emitters each include, for example, an insulating layer arranged on the picture signal interconnections, partially including a thin-film portion serving as an electron emission region (“an electron emitter opening”), the picture signal interconnections serving as the bottom electrode (the first electrode); and an upper electrode (second electrode) being connected to the scanning signal interconnections, covering the insulating layer including the thin-film portion, and serving as a top electrode. The insulating layer is an anodized layer and has defects, if any, in a number of about 3×10¹⁹ or less per cubic centimeter. The insulating layer may have a thickness of about 5 nm to about 15 nm.

By reducing the number of defects in an insulating layer constituting an electron acceleration layer of a thin-film electron emitter to 3×10¹⁹ or less per cubic centimeter, the resulting insulating layer shows a reduced leak current, and this realizes thin-film electron emitters having a higher reliability and a longer life, and image display devices using the thin-film electron emitters and having such excellent properties.

Further objects, features and advantages of the present invention will become apparent from the following description of the preferred embodiments with reference to the attached drawings.

### BRIEF DESCRIPTION OF THE DRAWINGS

FIG. 1 is a diagram showing the operation principle of thin-film electron emitters;

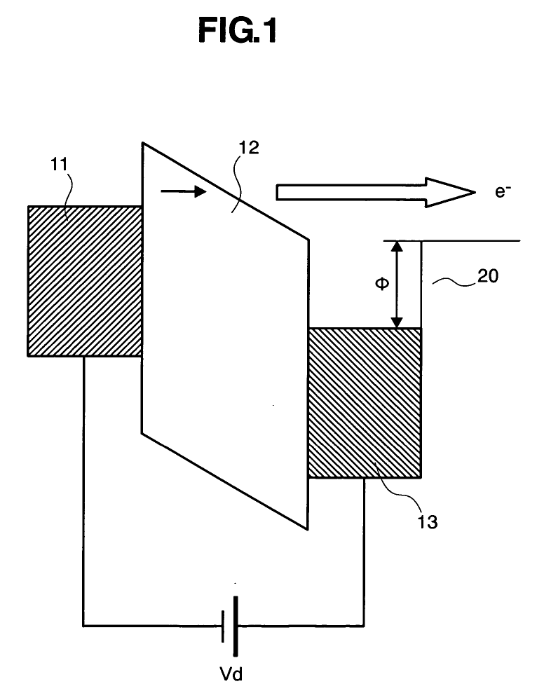

FIG. 2 shows views of a production method of a thin-film electron emitter according to the present invention;

FIG. 3 shows views of the production method of the thin-film electron emitter according to the present invention, subsequent to FIG. 2;

FIG. 4 shows views of the production method of the thin-film electron emitter according to the present invention, subsequent to FIG. 3;

FIG. 5 shows views of the production method of the thin-film electron emitter according to the present invention, subsequent to FIG. 4;

FIG. 6 shows views of the production method of the thin-film electron emitter according to the present invention, subsequent to FIG. 5;

FIG. 7 shows views of the production method of the thin-film electron emitter according to the present invention, subsequent to FIG. 6;

FIG. 8 shows views of the production method of the thin-film electron emitter according to the present invention, subsequent to FIG. 7;

FIG. 9 shows views of the production method of the thin-film electron emitter according to the present invention, subsequent to FIG. 8;

FIG. 10 shows views of the production method of the thin-film electron emitter according to the present invention, subsequent to FIG. 9;

FIG. 11 shows views of a front substrate of an image display device using the thin-film electron emitter according to the present invention;

FIG. 12 shows cross-sectional views of the display device using the thin-film electron emitter according to the present invention;

FIG. 13 is a schematic flow chart of a production process of the image display device according to the present invention;

FIG. 14 is a diagram showing the anodizing profile of an anodized film for use in the thin-film electron emitter according to the present invention;

FIG. 15 is a diagram showing anodizing conditions of thin-film electron emitter samples prepared in an experiment in First Embodiment in the present invention;

FIG. 16 is a schematic diagram of a system for measuring a thermally stimulated current so as to determine the defect density of the thin-film electron emitter samples prepared in an experiment in First Embodiment in the present invention;

FIG. 17(a) is a schematic graph of a general relation between the defect level and the defect density observed with the measuring system of FIG. 16; and FIG. 17(b) is a table showing the measured results of the thin-film electron emitter samples prepared in the experiment in First Embodiment in the present invention;

FIG. 18 is a schematic diagram of a system configuration for determining the lives (lifetimes) of thin-film electron emitters;

FIG. 19 is a graph showing the relationship between the operation time and the current in the thin-film electron emitters prepared in an experiment in First Embodiment;

FIG. 20 is a schematic diagram of a system configuration for evaluating the lives (lifetimes) of image display devices using the thin-film electron emitters; and

FIG. 21 is a graph showing the relationship between the operation time and the luminance of image display devices using the thin-film electron emitters prepared in an experiment in First Embodiment.

### DESCRIPTION OF THE PREFERRED EMBODIMENTS

Some embodiments of the present invention will be illustrated in detail with reference to the attached drawings.

### First Embodiment

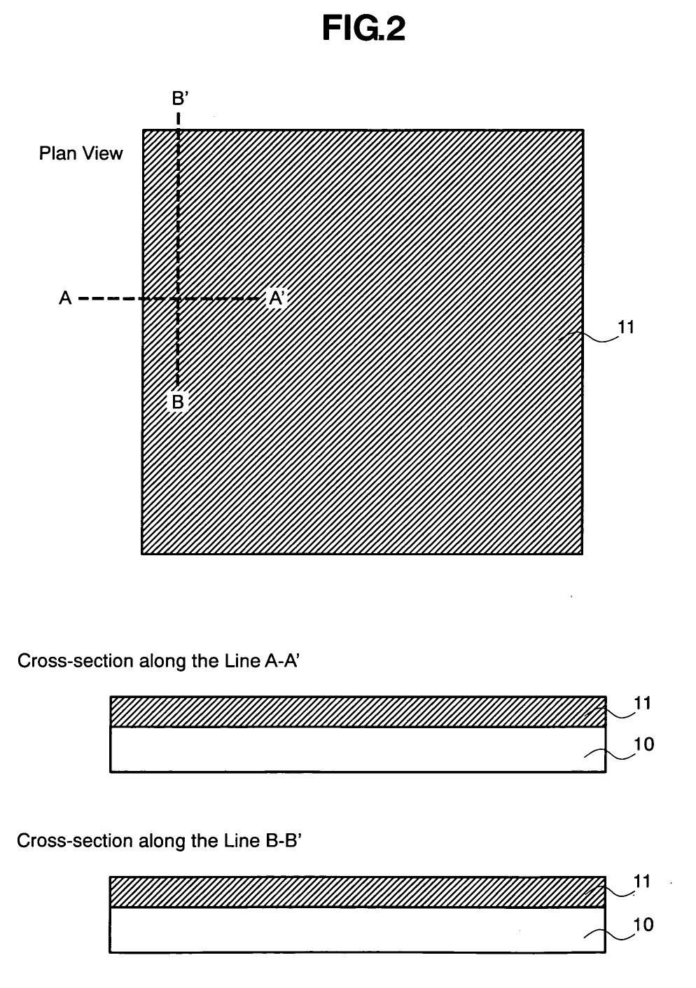

FIGS. 2 to 10 each shows a plan view and cross-cross-sectional views, respectively, of a principal part relating to the production method of the thin-film electron emitter according to the present invention. These figures sequentially show the shapes (planar structures) in the principal surfaces (planes) of a thin-film electron emitter and an insulating substrate 10 in the course of its formation, and the shapes of layers (sectional structure) on the principal surface of the insulating substrate 10 in the sequential steps from FIG. 2 to FIG. 10. Initially, a metal film for a bottom electrode (first electrode) is deposited on the insulating substrate 10. The insulating substrate 10 is preferably made of glass. Aluminum (Al) and/or an aluminum alloy can form a good insulating film (dielectric film) and is preferable as a material for the bottom electrode. In this embodiment, an Al—Nd alloy doped with 2 atomic percent of neodymium (Nd) may be used as a material for the bottom electrode layer 11 (in FIG. 2, before patterning). A film of the Al—Nd alloy is deposited, for example, by sputtering to a thickness of, for example, about 300 nm (FIG. 2).

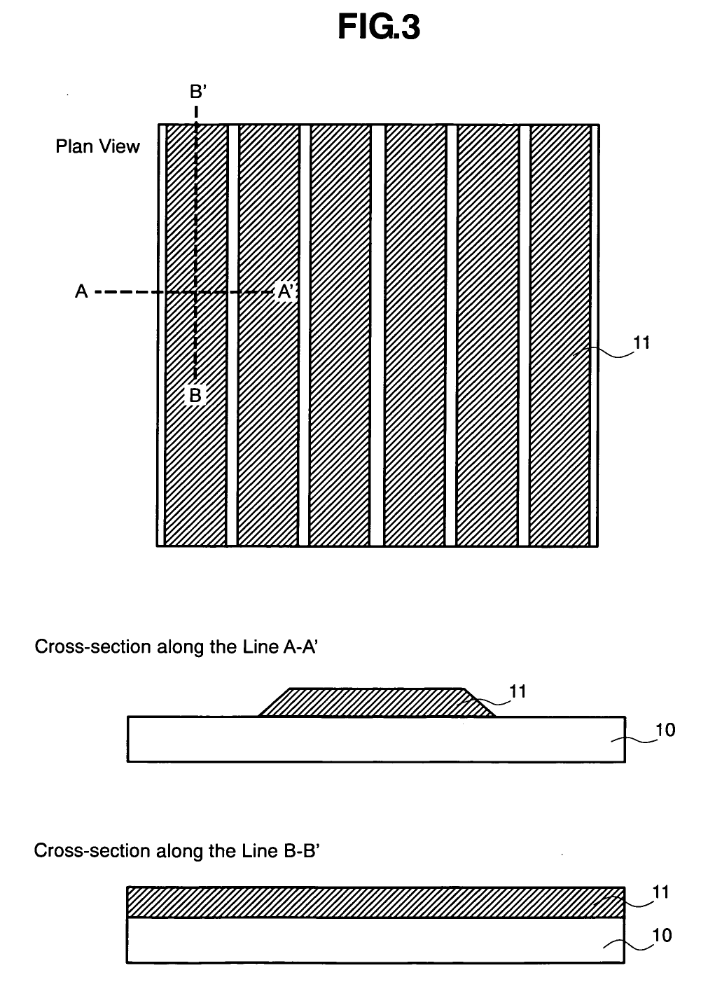

After depositing a film of the Al—Nd alloy, a photolithographic process and an etching process are conducted to pattern the Al—Nd alloy film (bottom electrode layer) to thereby form a stripe bottom electrode 11. The etching of the Al—Nd film is carried out, for example, by wet etching using an aqueous mixed solution of phosphoric acid, acetic acid, and nitric acid (FIG. 3).

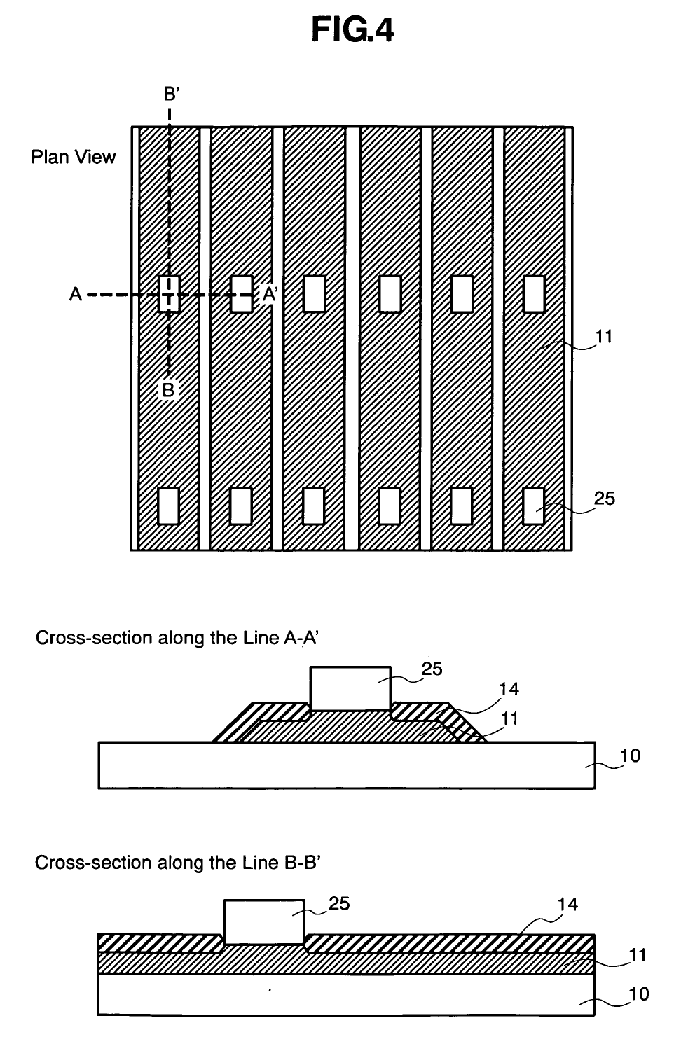

Next, anodic oxidation (anodization) is performed to the bottom electrode 11 (Al—Nd alloy film) to thereby form an insulating protection layer 14 which limits an electron emission portion on the surface of the bottom electrode 11 and prevents the concentration of electric field to edges of the bottom electrode 11. Then, an insulating layer 12 serving as an electron acceleration layer is formed. Initially, a portion of the bottom electrode 11 to be an electron emission portion is masked with a resist film 25, and the other region than the electron emission portion in the surface of the bottom electrode 11 is selectively thickly anodized to thereby form an insulating protection layer 14 (FIG. 4). When the anodizing voltage is set at 100 V, an insulating protection layer 14 having a thickness of about 140 nm is formed.

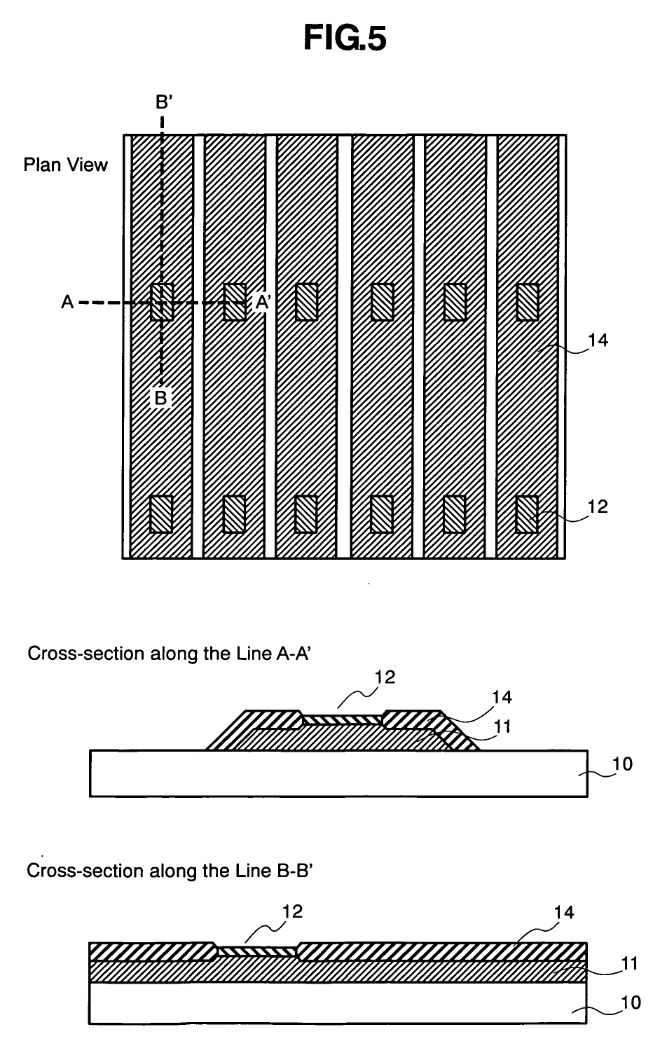

Next, the resist film 25 is stripped, and anodic oxidation is performed to a residual non-anodized surface of the bottom electrode 11. By setting the formation voltage in the anodic oxidation step at, for example, 0.6 V, an electron acceleration layer 12 (anodized film) having a thickness of about 10 nm is formed on the bottom electrode 11 (FIG. 5). Next, a heat treatment is conducted for the sublimation-desorption of water (moisture) and impurities in the insulating protection layer 14 and the electron acceleration layer (insulating layer 12) and those on the surface of the electron acceleration layer.

In the thin-film electron emitter according to First Embodiment, the intensity of an electric field applied to the insulating layer 12 serving as the electron acceleration layer is about 1 to about 10 MV/cm. When the film thickness of the electron acceleration layer is decreased, the voltage applied to between the bottom electrode 11 and the top electrode 13 sandwiching the electron acceleration layer must be decreased. With a decreasing applied voltage, however, the amount of hot electrons having energy equal to or greater than the work function φ of the top electrode 13 and being emitted into a vacuum 20 decreases. Consequently, if the electron acceleration layer (insulating layer) 12 has an excessively small film thickness, the resulting thin-film electron emitter using the electron acceleration layer may not significantly serve as a highly efficient electron emitter.

In contrast, when the film thickness of the electron acceleration layer is increased, necessary field intensity can be obtained by increasing the applied voltage to between the bottom electrode 11 and the top electrode 13. With an increasing applied voltage, the amount of hot electrons having energy equal to or greater than the work function φ of the top electrode 13 increases. However, with an increasing film thickness of the electron acceleration layer (insulating layer) 12, the amount of electrons that are scattered therein also increases. Consequently, if the electron acceleration layer (insulating layer) 12 has an excessively great film thickness, the resulting thin-film electron emitter using the electron acceleration layer may not significantly serve as a highly efficient electron emitter.

Accordingly, the experiments have revealed that the film thickness of the electron acceleration layer (insulating layer 12) of the thin-film electron emitter has an optimum range, and the thin-film electron emitter can serve as a highly efficient electron emitter when the film thickness is within a range of about 5 nm to about 15 nm. In this embodiment, the insulating layer 12 may be formed to a film thickness of 10 nm. To form an insulating layer 12 having a thickness of about 10 nm on the bottom electrode 11 by anodic oxidation of the bottom electrode 11, the anodizing voltage in the anodic oxidation may be set at about 6 V. The formation voltage in the anodic oxidation is preferably set at about 3V for forming an insulating layer 12 having a thickness of about 5 nm, and is preferably set at about 9 V for forming an insulating layer 12 having a thickness of about 15 nm.

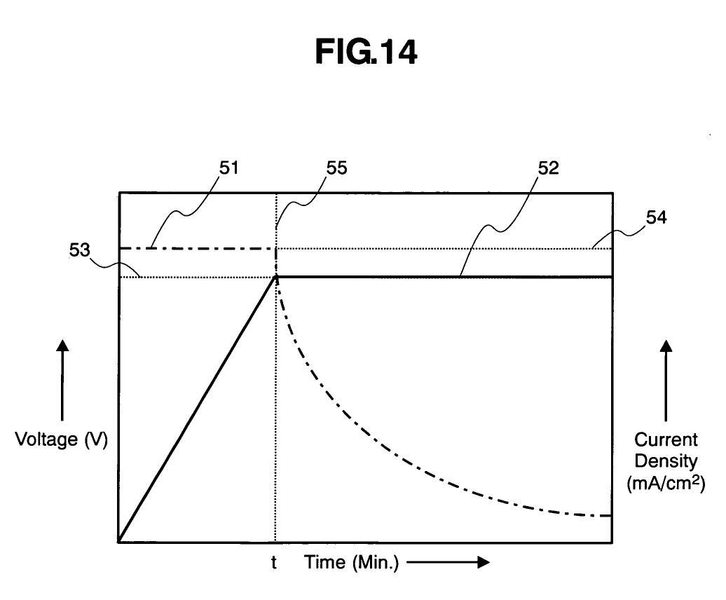

FIG. 14 is a diagram showing the formation profile of an anodized film for use in the thin-film electron emitter according to the embodiment of the present invention. Such an anodized film of the thin-film electron emitter can be formed, for example, by immersing the bottom electrode (first electrode) 11 and another electrode than the bottom electrode 11 in a liquid called “forming solution”, and applying a voltage to between the two electrodes; The “another electrode than the bottom electrode 11” is, for example, not provided at a base member (the insulating substrate 10) having the bottom electrode 11 provided thereat, as it were, configured as an external electrode with respect to the base member, and is also referred to as “cathode for anodizing.” The voltage or current (current density) mentioned below with reference to FIG. 14 is applied to between or passes between the cathode for anodizing and the bottom electrode 11 during the anodic oxidation of the bottom electrode (first electrode) 11, and is referred as “an interelectrode voltage” or “an interelectrode current,” respectively in the following explanations. In FIG. 14, alternate long and short dash lines 51 indicate the change the interelectrode current, and a solid line 52 indicates the change the interelectrode voltage. During “t” minutes from Time 0 to Time “t” shown by dotted lines 55, the interelectrode voltage 52 rises up to a predetermined voltage (anodization voltage) shown by dotted lines 53, while the interelectrode current 51 is held to a constant current density (oxidation current) shown by dotted lines 54. The voltage 52 starts rising from Time 0 and finishes rising at Time “t” by reaching the anodization voltage shown by dotted lines 53. Since the interelectrode current 51 is maintained constant during the time period of “t” (minutes), this time period is also called as “a constant current period.” A time period after the Time “t” shown by the dotted lines 55 is also called as “constant voltage period”, since the interelectrode voltage 52 is maintained constant during this time period. In other words, the anodizing voltage is applied to between the cathode for anodizing and the bottom electrode 11 (the electrode on which an anodized film is to be formed) during the “constant voltage period.” The interelectrode current (current density) maintained constant during the “constant current period” gradually decreases after the beginning of the “constant voltage period.”

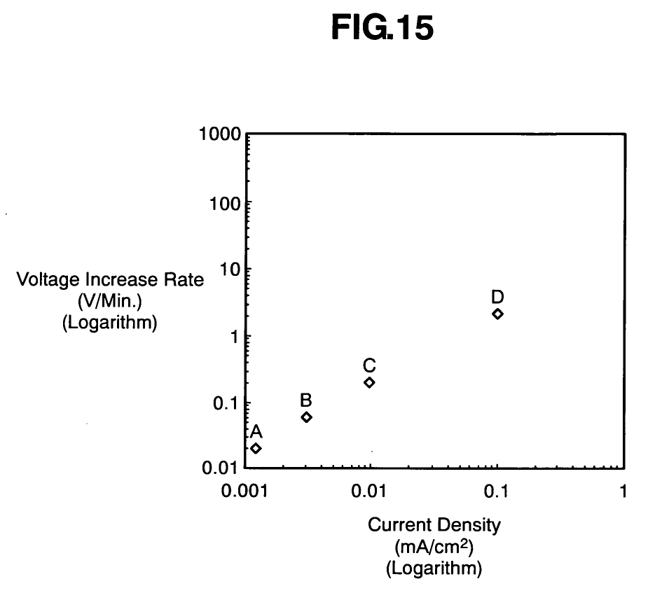

FIG. 15 is a diagram showing anodizing conditions of the insulating layer (electron acceleration layer) 12 in thin-film electron emitter samples prepared in an experiment. The anodizing conditions of the insulating layer 12 (anodic oxidation conditions of the bottom electrode 11) in four samples are different from one another and are represented by following Conditions A, B, C, and D.

Condition A: the interelectrode current density of 0.001 mA/c² and an increasing rate of the interelectrode voltage of 0.02 V per minute

Condition B: the interelectrode density of 0.003 mA/cm² and an increasing rate of the interelectrode voltage of 0.06 V per minute

Condition C: the interelectrode current density of 0.010 mA/cm² and an increasing rate of the interelectrode voltage of 0.2 V per minute

Condition D: the interelectrode current density of 0.100 mA/cm² and an increasing rate of the interelectrode voltage of 2 V per minute

Conditions A, B, C, and D are shown in FIG. 15.

The water (moisture) and impurities inside the insulating protection layer 14 and the electron acceleration layer (insulating layer 12) formed on or above the bottom electrode 11, or those on a surface of the electron acceleration layer are sublimated and desorbed by heat treatment of the insulating substrate 10 having these layers formed thereon. While the description of the heat treatment with reference to the drawings is omitted, the heat treatment is carried out, for example, using a heating device such as a hot-air baking oven, a hot plate, or an infrared baking oven. The heating temperature may be set, for example, within a range from about 150° C. to about 200° C.

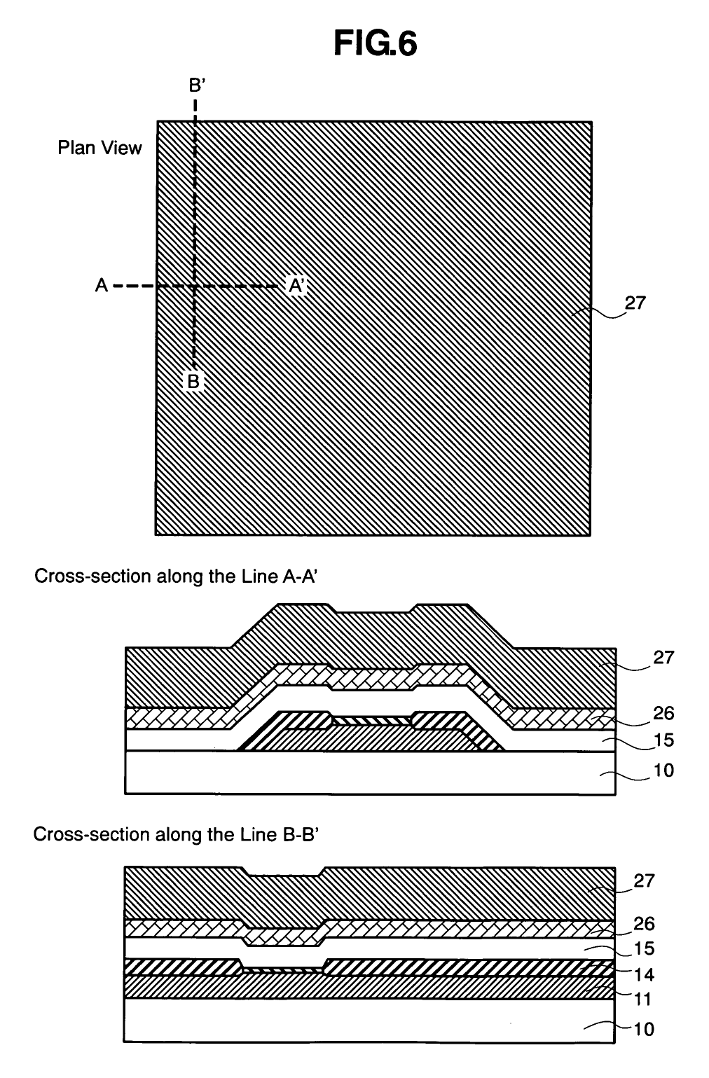

Next, a second insulating protection layer 15, a first metal layer (top bus electrode) 26, and a second metal layer 27 are sequentially deposited by e.g. sputtering so as to cover the insulating protection layer 14, the electron acceleration layer (insulating layer) 12, and the principal surface of the insulating substrate 10 on which these layers are formed. A contact hole (an opening) is formed in the second insulating protection layer 15 in an after-mentioned step so as to expose the electron acceleration layer 12 of the thin-film electron emitter. The first metal layer 26 and the second metal layer 27 sequentially arranged on the second insulating protection layer 15 are formed into a “top bus electrode film” in an after-mentioned step. The top bus electrode will serve as a feeder to the top electrode (second electrode) 13 of the thin-film electron emitter. In this embodiment, the second insulating protection layer 15 can be formed from silicon nitride to a film thickness of 100 nm. The second insulating protection layer fills pinholes in the insulating protection layer 14, if any, formed as a result of anodic oxidation so as to maintain the insulation between the bottom electrode 11 and the top bus electrode. Chromium (Cr) and an Al—Nd alloy can be used as materials for the first metal layer (after-mentioned top bus electrode) 26 and the second metal layer 27, respectively. The material for the first metal layer 26 also includes, for example, molybdenum (Mo), tungsten (W), titanium (Ti), or niobium (Nb), and the material for the second metal layer 27 also includes Al, copper (Cu), Cr, and a Cr alloy, in addition to the above-mentioned materials. The first metal layer 26 may have a film thickness of several ten nanometers, and the second metal layer 27 may have a film thickness of several micrometers (FIG. 6).

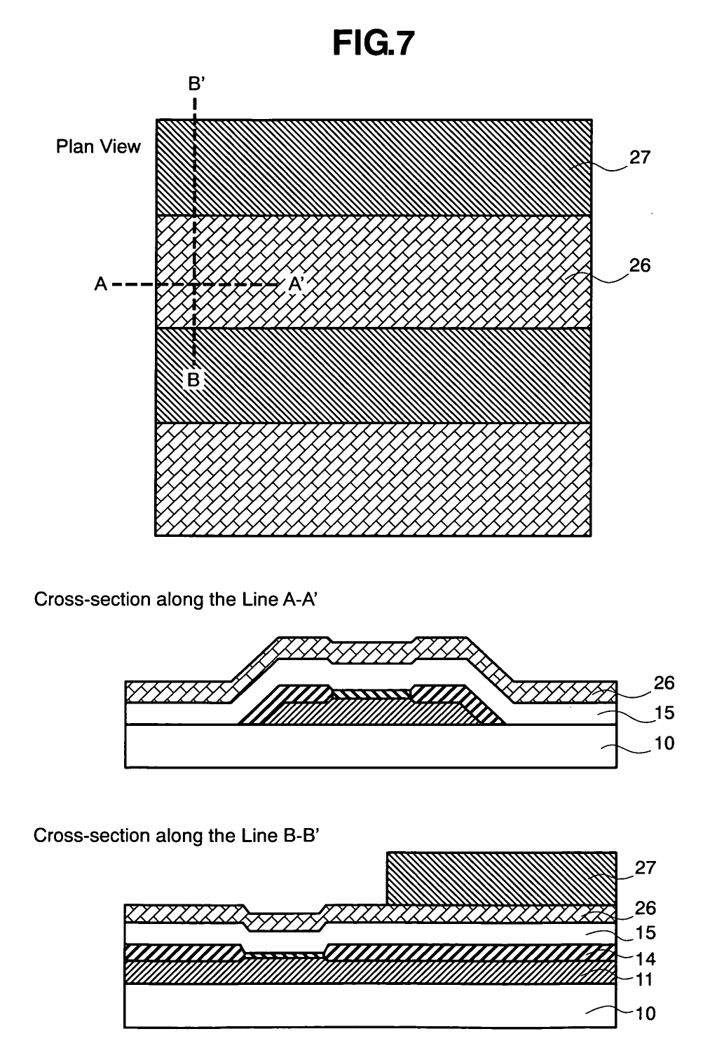

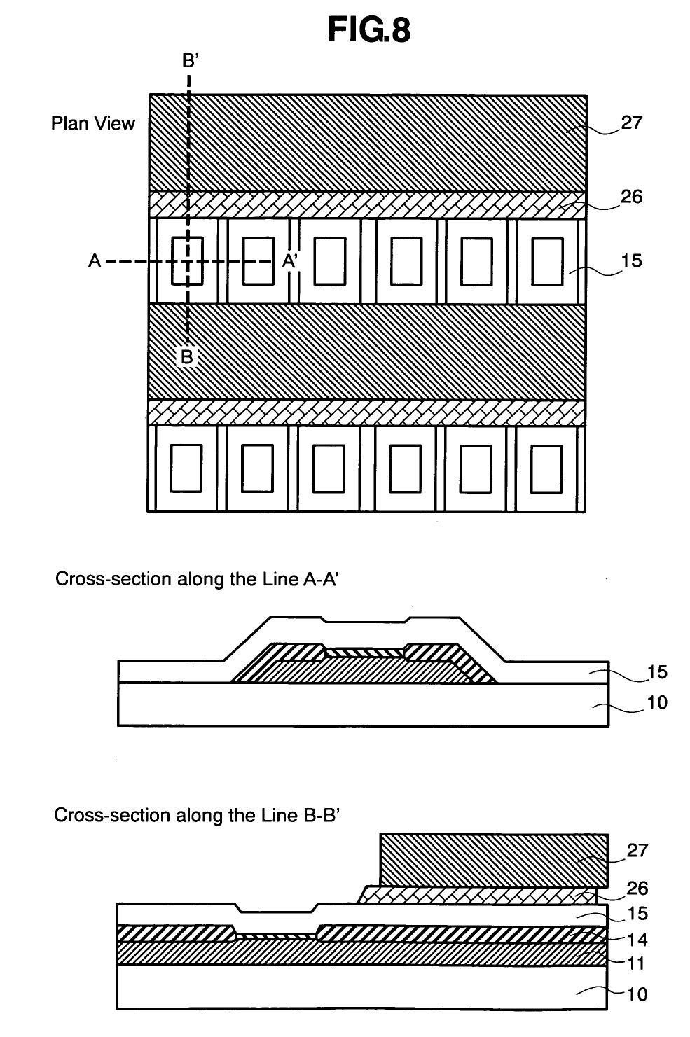

The second metal layer 27 and the first metal layer 26 are sequentially formed by a photo-etching step into linear traces extending in a direction intersecting (for example, perpendicularly) with the extending direction of the bottom electrode 11. The bottom electrode 11 is shown as races (stripe) extending in a vertical direction and being arranged in parallel (juxtaposed) in a longitudinal direction in the plan views of FIG. 3 and FIG. 4. As is shown in the plan view of FIG. 6, the first metal layer 26 and the second metal layer 27 formed as so-called solid patterns on or above the second insulating protection layer 15 are formed into traces (stripes) extending in a longitudinal direction and being arranged in parallel in a vertical direction in the steps shown in FIGS. 7 and 8, respectively. The first metal layer 26 and the second metal layer 27 are formed as shown in FIGS. 7 and 8, respectively, by wet etching using an etchant. The etchant for etching-chromium as the first metal layer 26 can be, for example, an aqueous diammonium cerium (IV) solution, and that for the Al—Nd alloy as the second metal layer 27 can be an aqueous mixed solution of phosphoric acid, acetic acid and nitric acid (FIG. 7 and FIG. 8).

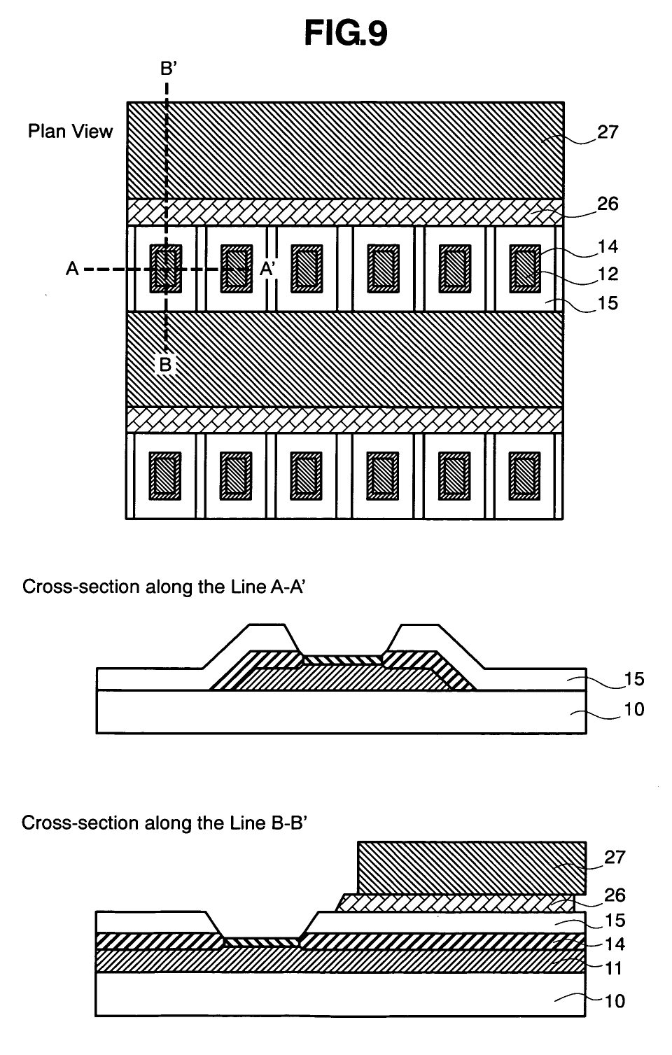

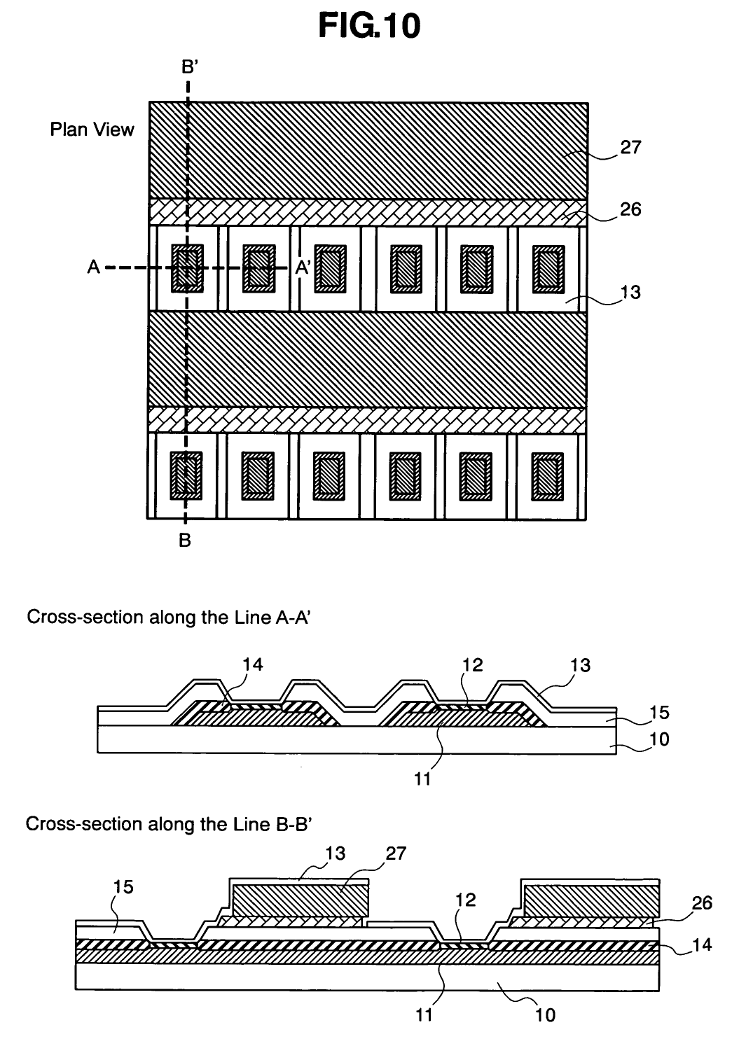

Next, the silicon nitride (SiN) of the second insulating protection layer 15 is subjected to dry etching to thereby open an electron emission portion (FIG. 9). Finally, a top electrode 13 is deposited. The deposition can be carried out, for example, by sputtering. The top electrode 13 can be formed, for example, as a multilayer having a film thickness of several nanometers and being formed by sequentially depositing iridium (Ir), platinum (Pt), and gold (Au). In this embodiment, the film thickness of the multilayer film can be set at about 5 nm. The deposited thin top electrode 13 is in contact with the Cr film as the first metal layer 26 and the Al—Nd film as the second metal layer 27, and a power is fed to the top electrode 13 from the top bus electrode film constituted by these layers (FIG. 10).

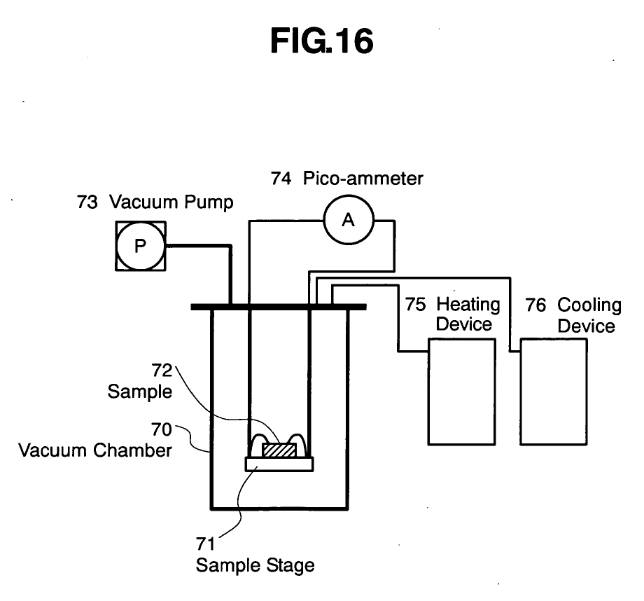

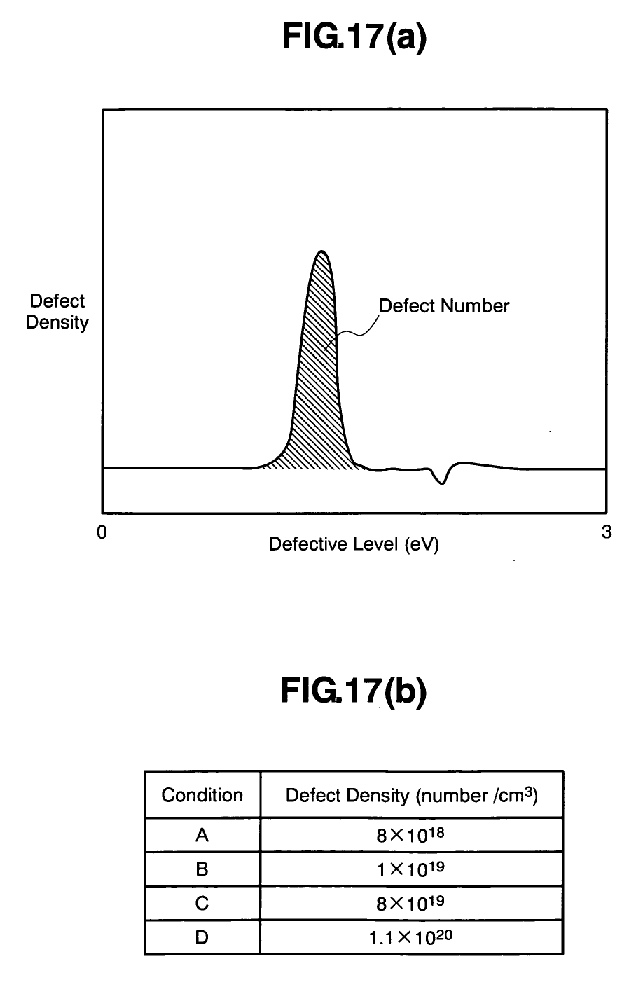

FIG. 16 is a schematic diagram of a system for measuring a thermally stimulated current so as to determine the defect density of the thin-film electron emitter samples prepared in an experiment in First Embodiment. FIG. 17(a) is a schematic graph of a general relation between the defect level and the defect density observed with the measuring system of FIG. 16; and FIG. 17(b) is a table showing the measured results of the four thin-film electron emitter samples prepared under Conditions A, B, C, and D in the experiment. With reference to FIG. 16, the thin-film electron emitter prepared by the above-mentioned process is placed as a sample 72 on a sample stage 71 arranged in a vacuum chamber 70. The inside of the vacuum chamber 70 is evacuated using a vacuum pump 73. The measuring system shown in FIG. 16 also includes a heating device 75 for heating the sample stage 71 and the sample 72, and a cooling device for cooling these components.

The inside of the vacuum chamber 70 is heated by the heating device 75 to thereby thermally stimulate the thin-film electron emitter (sample 72), and the change in current of the thin-film electron emitter is determined with a pico-ammeter (or a micro-ammeter) 74. Defects of the anodized film of the thin-film electron emitter are evaluated by the change in current. Specifically, the defects of the anodized film are evaluated in terms of defect density at the defect level, as illustrated in FIG. 17(a). FIG. 17(b) shows the defect densities in the four thin-film electron emitters prepared under Deposition Conditions A, B, C, and D, respectively. These results demonstrate that the thin-film electron emitters prepared under Deposition Conditions A and B have significantly lower defect densities than those prepared under Deposition conditions C and D.

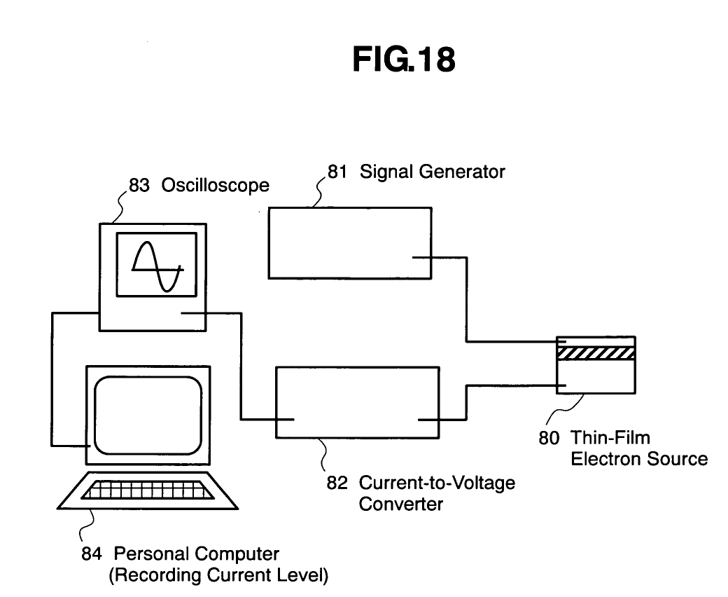

FIG. 18 is a schematic diagram of a system configuration for evaluating the lives of thin-film electron emitters prepared in the experiment in First Embodiment. The life of a sample thin-film electron emitter is evaluated by applying signals for the actual operation (image display operation) of the thin-film electron emitter to the thin-film electron emitter and determining the change in current of the thin-film electron emitter. With reference to FIG. 18, a pulse (drive signal) is applied from a signal generator 81 to the thin-film electron emitter 80. In this procedure, a current generated in the thin-film electron emitter is observed via a current/voltage converter 82 by an oscilloscope 83 and is recorded typically in a personal computer 84.

In general, thin-film electron emitters for use as elements (electron emitters) in image display devices must have a life of about 10000 hours or longer. The life of a thin-film electron emitter is defined, for example, as the time period within which the current generated in the thin-film electron emitter falls 50% or less of its initial current (determined at the beginning of the measurement) in the above-mentioned determination. In the present invention, the life of an image display device is determined by applying a pulse having a voltage within the range of 0 V to 10 V and a duration of about 100 μsec (microseconds) to the thin-film electron emitter in the image display device repeatedly sixty times per second. In the life evaluation test of thin-film electron emitters (image display devices) in this embodiment, the voltage of the pulse is set at 10 V, the most severe condition for evaluation of the life, and the pulse is continuously applied to the thin-film electron emitter. In the determination of the life of a thin-film electron emitter in this embodiment, the current passing through the thin-film electron emitter is measured before the application of the pulse to the thin-film electron emitter (initial current), and also measured 1, 10, 1000, and 1500 hours after the beginning of the measurement (the begging of continuous application of the pulse to the thin-film electron emitter), and the current reductions are calculated by subtracting the measured currents from the initial current (the current determined before the application of the pulse), respectively. The life of the thin-film electron emitter herein is defined as an estimated current 10000 hours after the beginning of the application of the pulse (beginning of determination) calculated by extrapolating these current reductions with respect to the initial current (for example, 0 before the application of the pulse) to the voltage application time. A thin-film electron emitter having an estimated current after continuous operation for 10000 hours of 50% or more of the initial current is evaluated as a good thin-film electron emitter.

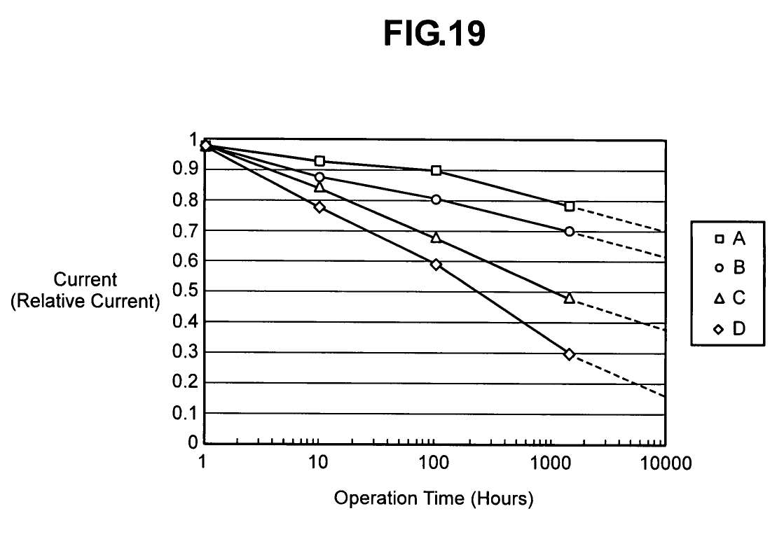

The determined lives of the samples of the four thin-film electron emitters are shown in FIG. 19. FIG. 19 demonstrates that the samples prepared under Conditions A and B each have a life of 10000 hours or longer, but those prepared under Conditions C and D and having higher defect densities than the former samples do not achieve a life of 10000 hours.

Thus, the thin-film electron emitters prepared according to the present invention can achieve longer lives, i.e., good electron emission properties over a longer time, by reducing defects in the thin films as the electron acceleration layers arranged between electrodes.

### Second Embodiment

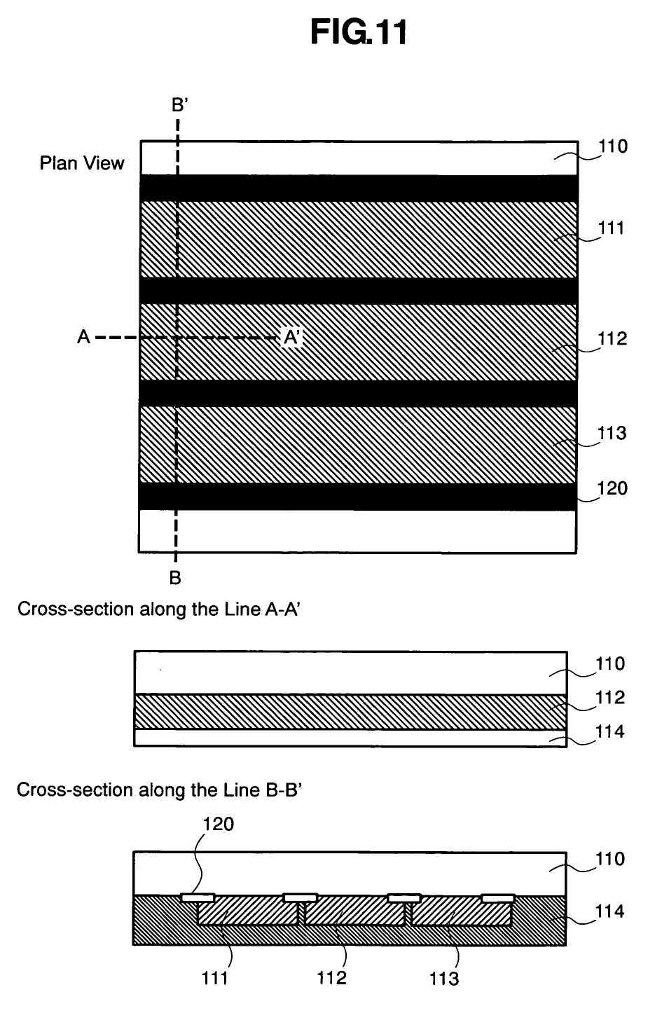

In this embodiment, an image display device (a display device according to the present invention) using a thin-film electron emitter array substrate (back substrate) including a plurality of the thin-film electron emitter arranged in a matrix, and a method for producing the image display device will be illustrated. The image display device comprises a back substrate prepared by the production processes as described in First Embodiment, i.e., a thin-film electron emitter array substrate shown in FIG. 10; a phosphor screen substrate having a phosphor screen and an anode on its principal surface (hereinafter referred to as “front substrate”) which will be described later with reference to FIG. 11; and a spacer. The back substrate is stuck to the front substrate with the interposition of the spacer.

FIG. 11 illustrates a front substrate of an image display device using the thin-film electron emitter according to the present invention. The front substrate can be prepared in the following manner. A substrate 110 can comprise, for example, optically transparent glass. Initially, a black matrix 120 is formed on a principal surface of the substrate 110 so as to increase the contrast of images displayed by the image display device. The black matrix 120 is prepared in the following manner.

A solution of a mixture of a poly (vinyl alcohol) (PVA) and sodium bichromate is applied to the substrate 110. The other portions than a portion where the black matrix 120 is to be formed are irradiated with and exposed to ultraviolet rays, and the unexposed portion is removed. A suspension of graphite powder is applied to the principal surface of the substrate 110 on which the pattern of PVA is formed in the way thus described, and the PVA pattern is lifted off to thereby yield the black matrix 120.

Next, a red phosphor layer 111 is formed. This phosphor layer (fluorescent substance layer) is patterned by applying an aqueous solution containing fluorescent substance particles, a PVA (poly(vinyl alcohol)), and ammonium bichromate to the substrate 110, exposing the portion where the phosphor layer is to be formed to ultraviolet rays, and removing the unexposed portion under running water. The red phosphor layer 111 is thus patterned into a stripe. Likewise, a green phosphor layer 112 and a blue phosphor layer 113 are formed. Recommended fluorescent substances for the formation of these phosphor layers are Y₂O₂S:Eu (P22-R) for the red phosphor layer 111; ZnS:Cu,Al (P22-G) for the green phosphor layer 112; and ZnS:Ag,Cl (P22-B) for the blue phosphor layer 113.

Next, filming with a film of nitrocellulose or the like is applied to the principal surface of the substrate 110 on which the black matrix 120 and the phosphor layers 111, 112, and 113 are formed, and then aluminum (Al) is vapor-deposited to a film thickness of about 75 nm overall the principal surface of the substrate 110 to form a metal backed screen 114. The metal backed screen 114 serves as an acceleration electrode that accelerates electrons emitted from the thin-film electron emitter (back substrate), namely, as an anode. The substrate 110 is then heated at about 400° C. in the air so as to thermally decompose organic substances such as the filming film and PVA. Thus, a displaying substrate (front substrate) is prepared. The front substrate lib and the back substrate 10 mentioned hereinbelow include not only the material insulating substrates 110 and 10 but also structures formed on their principal surfaces, such as thin films.

A frame 116 arranged on the peripheries of the thus-prepared front substrate 110 and the back substrate 10 is sealed to the principal surfaces of these substrates with the interposition of a spacer 40 using a fritted glass 115. The sealing step is carried out in the air so as to drive off organic binders contained in the paste of the fritted glass, and to save facilities and steps for replacing gases in the atmosphere to thereby reduce the production cost of the image display device.

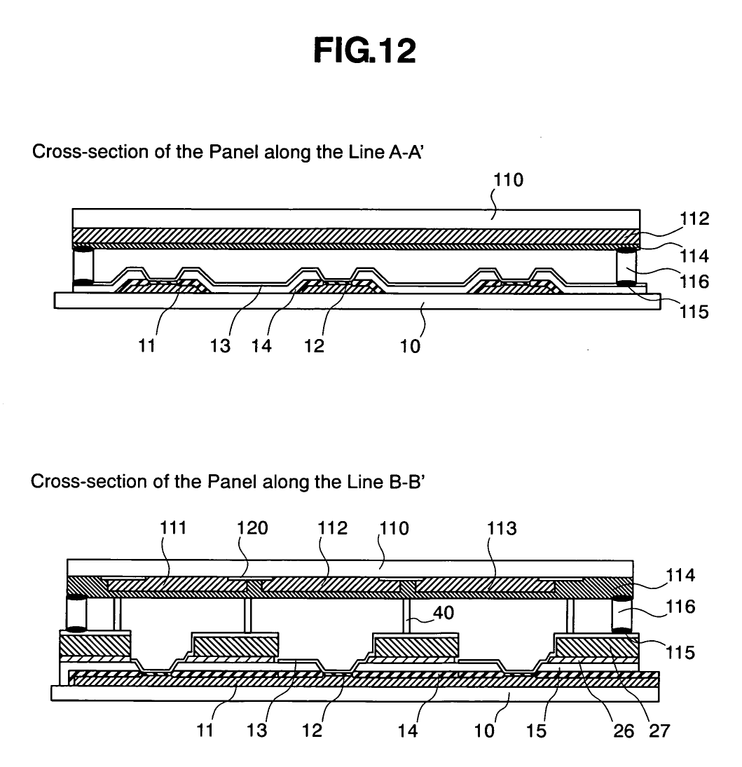

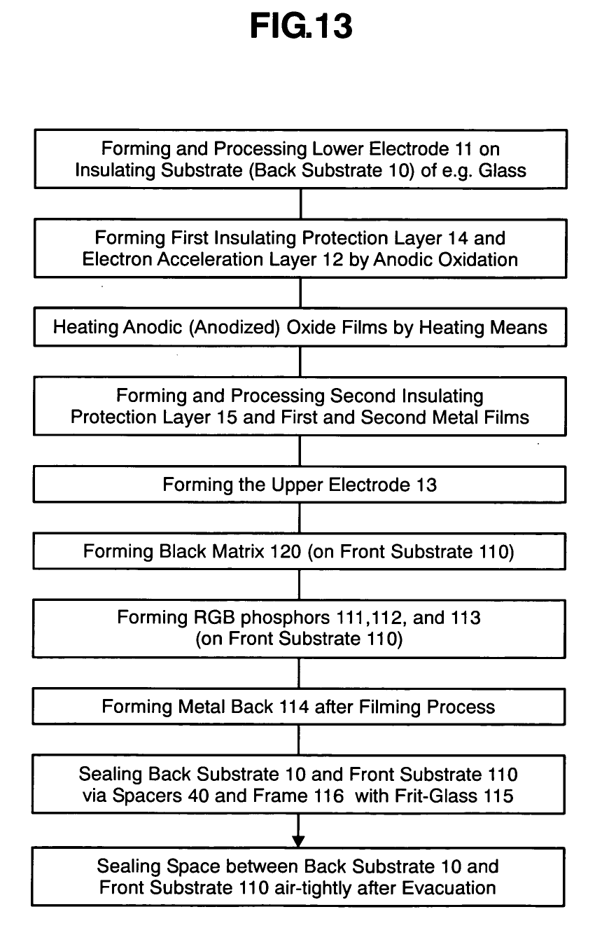

FIG. 12 illustrates the cross sections of an image display device using the thin-film electron emitter according to the present invention. The image display device (hereinafter also referred to as display panel) is prepared, for example, by sticking the principal surface of the back substrate in FIG. 10 and the principal surface of the front substrate in FIG. 11 to each other according to the above sealing step so as to allow the line A-A′ and the line B-B′ to face each other, respectively. FIG. 12 shows portions corresponding to the cross section along the line A-A′ and the cross section along the line B-B′ of the thus-stuck display panel, respectively. The height of the spacer 40 may be set so that the distance between the front substrate 110 and the back substrate 10 falls within a range of about 1 to about 5 mm. For the sake of explanation, the spacers 40 are arranged in every dot of the R (red), G (green), and B (blue) fluorescent substances in the device of FIG. 12. However, the number (density) of the spacers 40 can be reduced within such a range that the resulting display panel can have certain mechanical strength. For example, the spacers 40 may be arranged at intervals of about 1 cm every several dots. The panel is sealed air-tightly so that the “space” formed between the principal surface of the back substrate 10 and the principal surface of the front substrate 110 is evacuated to a vacuum of about 10⁻⁷ Torr. FIG. 13 schematically illustrates the entire production process of the image display device using the thin-film electron emitter according to the present invention.

After air-tightly sealing the display panel, a getter (gettering substance) which has been arranged in the “space” is activated to thereby maintain the vacuum in the display panel. When the gettering substance mainly comprises, for example, barium (Ba), a getter film can be formed by applying high-frequency induction heating to the gettering substance. An involatile getter mainly comprising zirconium (Zr) may also be used as the gettering substance.

In the display panel according to this embodiment, the front substrate 110 and the back substrate 10 are arranged at a relatively long distance of about 1 to about 5 mm, and the acceleration voltage to be applied to the metal-backed screen 114 can therefore be set at a relatively high level of about 3 to about 10 KV. Consequently, the display panel according to this embodiment can use fluorescent substances for cathode ray tubes (CRTs) in the phosphor layers, as described above.

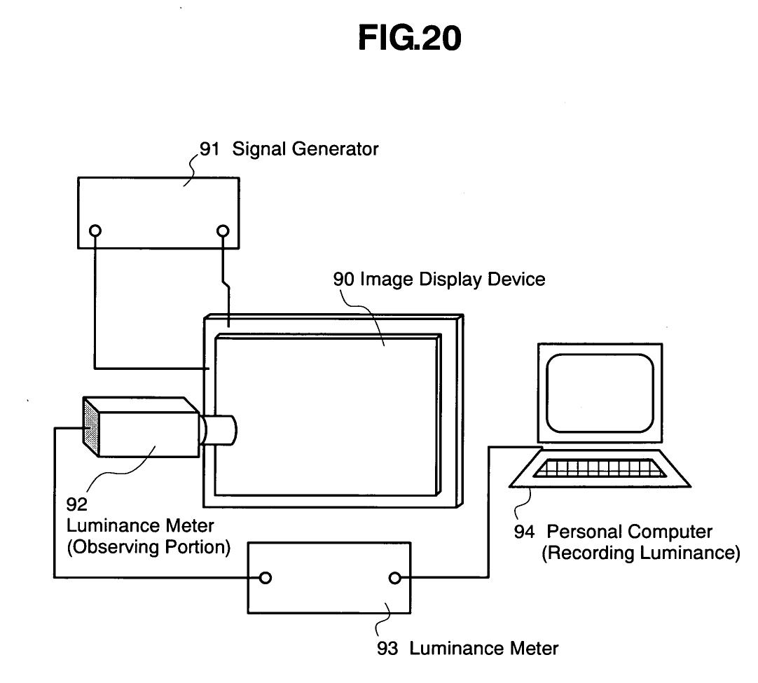

FIG. 20 is a schematic diagram of a system configuration for evaluating the life of an image display device using the thin-film electron emitter prepared in Second Embodiment. As in First Embodiment, the life of the image display device (i.e., the life of its thin-film electron emitter) is evaluated by measuring the change in luminance of the image display device upon application of a signal for the actual operation (image display operation) of the device or a similar signal to the thin-film electron emitter. Specifically, a pulse is applied from a signal generator 91 to the image display device 90, and the luminance thereof is measured using an observing unit 92 of a luminance meter and the luminance meter 93. The measured result is recorded, for example, in a personal computer 94.

In the evaluation of the life of an image display device in this embodiment, the time at which the luminance of the image display device becomes 50% of the initial luminance is defined as the life of the image display device, as in the evaluation of the life of a thin-film electron emitter described in First Embodiment. The initial luminance is defined as the luminance of, for example, display screen of the image display device before the initiation of the step for measuring the life of the image display device as mentioned below. In the measurement of the life of the image display device according to the present invention, a pulse having a voltage in the range of 0 V to 10 V and a duration of about 100 μsec is applied from the signal generator 91 to the image display device 90 repeatedly sixty times per second. In this experiment, the voltage of the pulse is set at 10 V, which is the most severe condition for evaluating the life of the image display device, and the pulse is continuously applied to the image display device. In the determination of the life of the image display devices in this experiment, the luminance of, for example, the display screen of the image display device 90 is measured before the application of the pulse to the image display device (initial luminance), and also measured 1, 10, 1000, and 1500 hours after the beginning of the measurement (the begging of continuous application of the pulse to the image display device), and the luminance reductions are calculated by subtracting the measured luminances from the initial luminance (the luminance determined before the application of the pulse), respectively. The life of the image display device herein is defined as an estimated luminance 10000 hours after the beginning of the application of the pulse (beginning of determination) calculated by extrapolating these luminance reductions with respect to the initial luminance (for example, 0 candela per square centimeter before the application of the pulse) to the voltage application hours. An image display device having an estimated luminance after continuous operation for 10000 hours of 50% or more of the initial luminance is evaluated as an image display device having a good thin-film electron emitter.

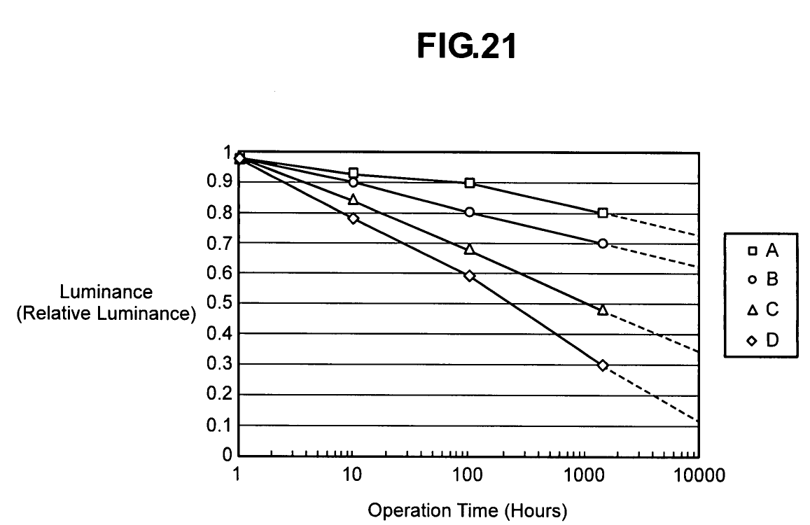

The lives of image display devices (samples) having the four thin-film electron emitters including the electron acceleration layers 12 formed under different conditions (anodic oxidation conditions) described in First Embodiment, respectively, were evaluated, and the results are shown in FIG. 21. FIG. 21 shows that the image display devices using the thin-film electron emitters prepared under Conditions A and B each have a life of 10000 hours or longer, but those using thin-film electron emitters prepared under Conditions C and D and having higher defect densities than those prepared under Conditions A and B do not achieve a life of 10000 hours.

The image display devices using the thin-film electron emitters prepared according to the present invention can have a longer life, namely, can maintain good image display quality over a longer time by positively reducing the amount, of defects in the thin films constituting the thin-film electron emitters (e.g., in the electron acceleration layer arranged between electrodes).

The present inventors made further investigations on the insulating layer (electron acceleration layer) 12 to be arranged between a pair of electrodes in the thin-film electron emitter so as to further improve the properties of the thin-film electron emitter according to First Embodiment, and of the image display device according to Second Embodiment using the thin-film electron emitter. As a result, they have found that, when the insulating layer (hereinafter also referred to as electron acceleration layer) is formed by an anodic oxidation step using one of the pair of electrodes, the resulting defect density can further be reduced by reducing at least one of the “increment of formation voltage” and “current density” in the time period of rise of the formation voltage (the above-mentioned constant current period) at the beginning of the anodic oxidation step to a level lower than Condition A described in First Embodiment. They have also found that the defect density in the electron acceleration layer can also be effectively reduced by reducing the variation (deviation) of the “increment of anodizing voltage” and/or the “current density” in the constant current period (i.e., the period of formation voltage rise). Consequently, they have verified that the defect density of the electron acceleration layer (anodized film) can be reduced to 6×10¹⁷ per cubic centimeter by further adjusting these anodic oxidation conditions.

To further reduce the defect density of the electron acceleration layer formed by anodic oxidation to a level below 6×10¹⁷ per cubic centimeter, the forming solution is preferably appropriately selected and the heat treatment of the electron acceleration layer after anodic oxidation is preferably set as appropriate. In other words, the method for producing a thin-film electron emitter according to the present invention can reduce the defect density of the electron acceleration layer to the above-mentioned level (6×10¹⁷ per cubic centimeter) in any event, regardless of the type of the forming solution and the heat treatment conditions of the electron acceleration layer.

The defect density of the electron acceleration layer in such a thin-film electron emitter has only to be 3×10¹⁹ or less per cubic centimeter from the viewpoint of industrial use of image display devices using the thin-film electron emitter. The life of the thin-film electron emitter is estimated to be prolonged to 50000 hours or longer when the defect density can be reduced to 8×10¹⁷ or less per cubic centimeter.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. A thin-film electron emitter comprising:
an insulating substrate;
a first electrode;
an insulating layer; and
a second electrode, each arranged in this order,
wherein the insulating layer is an anodized layer and has defects, if any, in a number of about 3×10¹⁹ or less per cubic centimeter.

2. The thin-film electron emitter of claim 1, wherein the insulating layer has a thickness of about 5 nm to about 15 nm.

3. The thin-film electron emitter of claim 1, wherein the first electrode comprises at least one of aluminum and an aluminum alloy.

4. The thin-film electron emitter of claim 1, wherein the insulating layer comprises an anodized oxide containing aluminum.

5. The thin-film electron emitter of claim 1, wherein the second electrode comprises at least one selected from the group consisting of an iridium film, a platinum film, a gold film, a silver film, a nickel film, and a multilayer film of two or more of these films.

6. A method for producing a thin-film electron emitter comprising an insulating substrate; a first electrode; an insulating layer; and a second electrode, each arranged in this order, the method comprising the steps of:
depositing a layer of at least one of aluminum and an aluminum alloy on the insulating substrate to thereby form the first electrode;
applying anodic oxidation to the first electrode under the application of an electric field at a current density of 0.01 mA/cm² or less and a voltage which increases at a rate of 0.15 V or less per minute to the highest value thereof 3 V to 9 V to thereby form the insulating layer; and
forming the second electrode so as to cover the insulating layer.

7. The method of claim 6, further comprising depositing at least one selected from the group consisting of an iridium film, a platinum film, a gold film, a silver film, a nickel film, and a multilayer film of two or more of these films as the second electrode.

8. An image display device comprising:
a back substrate;
a front substrate facing the back substrate at a predetermined distance to form an inner space; and
a sealing frame arranged on the peripheries of the back substrate and the front substrate so as to seal and hold the inner space to a predetermined vacuum,
wherein the back substrate comprises:
plural scanning signal interconnections extending in one direction on the insulating substrate and being arranged in parallel in another direction intersecting with the one direction, scanning signals being to be applied to the scanning signal interconnections sequentially in the other direction;
plural picture signal interconnections extending in the other direction and being arranged in parallel in the one direction so as to intersect with the scanning signal interconnections;
thin-film electron emitters arranged at intersections between the scanning signal interconnections and the picture signal interconnections; and
bus electrodes each connected to the scanning signal interconnections so as to supply a current to the thin-film electron emitters,
wherein the thin-film electron emitters each comprise:
an insulating layer arranged on the picture signal interconnections, partially comprising a thin-film portion serving as an electron emission region so as to form an electron emitter opening, the picture signal interconnections serving as first electrodes so as to serve as bottom electrodes; and
second electrodes each connected to the scanning signal interconnections, covering the insulating layer including the thin film portion, and serving as top electrodes, and
wherein the insulating layer is an anodized layer and has defects, if any, in a number of about 3×10¹⁹ or less per cubic centimeter.

9. The image display device of claim 8, wherein the insulating layer has a thickness of about 5 nm to about 15 nm.

10. The image display device of claim 8, wherein the first electrodes each comprise at least one of aluminum and an aluminum alloy.

11. The image display device of claim 8, wherein the insulating layer comprises an anodized oxide containing aluminum.

12. The image display device of claim 8, wherein the second electrodes each comprise at least one selected from the group consisting of an iridium film, a platinum film, a gold film, a silver film, a nickel film, and a multilayer film of two or more of these films.
